(19) United States
(12) Patent Application Publication
(10) Pub. No.: US 2007/0177331 A1
(43) Pub. Date: Aug. 2, 2007

(54) Non-flaking capacitor material, capacitive substrate having an internal capacitor therein including said non-flaking capacitor material, and method of making a capacitor member for use in a capacitive substrate

(75) Inventors: Rabindra N. Das, Vestal, NY (US); John M. Lauffer, Waverly, NY (US); Voya R. Markovich, Endwell, NY (US); Kostas I. Papathomas, Endicott, NY (US)

Correspondence Address: LAWRENCE R. FRALEY;Hinman, Howard & Kattell, LLP, 700 Security Mutual Building, 80 Exchange Street, Binghamton, NY, 13902-5250, US

(73) Assignee: Endicott Interconnect Technologies, Inc., Endicott, NY (US)

(21) Appl. No.: 11/730,761

(22) Filed: Apr. 4, 2007

Related U.S. Application Data
(63) Continuation-in-part of application No. 11/352,279, filed on Feb. 13, 2006.
Application No. 11/352,279 is a continuation-in-part of application No. 11/172,794, filed on Jul. 5, 2005.
Application No. 11/172,794 is a continuation-in-part of application No. 11/031,085, filed on Jan. 10, 2005.

(51) Int. Cl. H01G 4/228

(52) U.S. Cl. 361/306.1; 29/25.41

(57) ABSTRACT

A capacitor material including a thermosetting resin (e.g., epoxy resin), a high molecular mass flexibilizer (e.g., phenoxy resin), and a quantity of nano-particles of a ferroelectric ceramic material (e.g., barium titanate), the capacitor material not including continuous or semi-continuous fibers (e.g., fiberglass) as part thereof. The material is adapted for being positioned in layer form on a first conductor member and heated to a predetermined temperature whereupon the material will not possess any substantial flaking characteristics. A second conductor member may then be positioned on the material to form a capacitor member, which then may be incorporated within a substrate to form a capacitive substrate. Electrical components may be positioned on the substrate and capacitively coupled to the internal capacitor.

### TECHNICAL FIELD

The present invention relates to capacitors and particularly to internal capacitors for use within circuitized substrates such as printed circuit boards, chip carriers and the like, to products including such internal capacitors as part thereof, and to methods of making such capacitors.

### CROSS REFERENCE TO PREVIOUS AND CURRENT CO-PENDING APPLICATIONS OF THE ASSIGNEE

In Ser. No. 11/031,074, entitled “Capacitor Material With Metal Component For Use In Circuitized Substrates, Circuitized Substrate Utilizing Same, Method of Making Said Circuitized Substrate, and Information Handling System Utilizing Said Circuitized Substrate” and filed Jan. 10, 2005, there is defined a material for use as part of an internal capacitor within a circuitized substrate in which the material includes a polymer resin and a quantity of nano-powders including a mixture of at least one metal component and at least one ferroelectric ceramic component, the ferroelectric ceramic component nano-particles having a particle size substantially in the range of between about 0.01 microns and about 0.9 microns and a surface within the range of from about 2.0 to about 20 square meters per gram. A circuitized substrate adapted for using such a material and capacitor therein and a method of making such a substrate are also defined. An electrical assembly (substrate and at least one electrical component) and an information handling system (e.g., personal computer) are also defined. Ser. No. 11/031,074 is now U.S. Pat. 7,025,607.

In Ser. No. 11/031,085, entitled “Capacitor Material For Use In Circuitized Substrates, Circuitized Substrate Utilizing Same, Method of Making Said Circuitized Substrate, and Information Handling System Utilizing Said Circuitized Substrate” and filed Jan. 10, 2005, there is defined a material for use as part of an internal capacitor within a circuitized substrate wherein the material includes a polymer (e.g., a cycloaliphatic epoxy or phenoxy based) resin and a quantity of nano-powders of ferroelectric ceramic material (e.g., barium titanate) having a particle size substantially in the range of from about 0.01 microns to about 0.90 microns and a surface area for selected ones of these particles within the range of from about 2.0 to about 20 square meters per gram. A circuitized substrate adapted for using such a material and capacitor therein and a method of making such a substrate are also defined. An electrical assembly (substrate and at least one electrical component) and an information handling system (e.g., personal computer) are also defined. In the examples discussed in this application, epoxy resin is mixed with hexahydro-4-methylphthalic anhydride, N,N dimethyl benzylamine and epoxy novolac resin. The mixed solution was stirred and barium titanate powder was added and formed into a screen printable paste. A layer of this material was screened through a 200 mesh screen onto the top surface of a copper first electrical conductor. This layer was then cured at approximately 150 degrees C. for about two hours, followed by an additional cure at approximately 190 degrees C. for about one hour. The second electrical conductor was then formed using a sputtering operation followed by a copper electroplating process and a photolithographic etch step.

In Ser. No. 11/172,794, entitled “Method Of Making An Internal Capacitive Substrate For Use In a Circuitized Substrate And Method Of Making Said Circuitized Substrate” and filed Jul. 5, 2005, there is defined a method of forming a capacitive substrate in which first and second conductors are formed opposite a dielectric, with one of these electrically coupled to a thru-hole connection. Each functions as an electrode for the resulting capacitor. The substrate is then adapted for being incorporated within a larger structure to form a circuitized substrate such as a printed circuit board or a chip carrier. Additional capacitors are also possible. In one of the examples (Example 5) cited in this pending application, epoxy novolac resin and a phenoxy resin are mixed together with barium titanate (BaTiO₃) powder and propylene glycol monomethyl ether acetate and methyl ethyl ketone and ball milled for three days. A 2.5 micron thin film of this mixed composite was deposited on a copper substrate and dried at approximately 140 degrees C. for three minutes in an oven to remove residual organic solvents. This was followed by curing in an oven at 190 degrees C. for two hours. A second electrical conductor was then formed using a sputtering operation atop the cured film using a mask normally used for such sputtering operations.

In Ser. No. 11/352,276, entitled “Method Of Making A Capacitive Substrate Using Photoimageable Dielectric For Use As Part Of A Larger Circuitized Substrate, Method of Making Said Circuitized Substrate and Method of Making An Information Handling System Including Said Circuitized Substrate” and filed Feb. 13, 2006, there is defined a method of forming a capacitive substrate in which at least one capacitive dielectric layer of material is screen or ink jet printed onto a conductor and the substrate is thereafter processed further, including the addition of thru-holes to couple selected elements within the substrate to form at least two capacitors as internal elements of the substrate. Photoimageable material is used to facilitate positioning of the capacitive dielectric being printed. The capacitive substrate may be incorporated within a larger circuitized substrate, e.g., to form an electrical assembly. A method of making an information handling system including such substrates is also provided.

In Ser. No. 11/352,279, entitled “Method Of Making A Capacitive Substrate For Use As Part Of A Larger Circuitized Substrate, Method of Making Said Circuitized Substrate and Method of Making An Information Handling System Including Said Circuitized Substrate” and also filed Feb. 13, 2006, there is defined a method of forming a capacitive substrate in which at least one capacitive dielectric layer of material is screen or ink jet printed onto a conductor and the substrate is thereafter processed further, including the addition of thru-holes to couple selected elements within the substrate to form at least two capacitors as internal elements of the substrate. The capacitive substrate may be incorporated within a larger circuitized substrate, e.g., to form an electrical assembly. A method of making an information handling system including such substrates is also provided. As in Example 5 of Ser. No. 11/172,794, epoxy novolac resin and a phenoxy resin are mixed together with barium titanate (BaTiO₃) powder and propylene glycol monomethyl ether acetate and methyl ethyl ketone and ball milled for three days. A 2.5 micron thin film of this mixed composite was then deposited on a copper substrate and dried at approximately 140 degrees C. for three minutes in an oven to remove residual organic solvents. This was followed by curing in an oven at 190 degrees C. for two hours. A second electrical conductor was then formed using a sputtering operation atop the cured film using a mask normally used for such sputtering operations.

In Ser. No. 11/541,776, entitled “Halogen-Free Circuitized Substrate With Reduced Thermal Expansion, Method of Making Same, Multilayered Substrate Structure Utilizing Same, and Information Handling System Utilizing Same”, filed Oct. 03, 2006, there is defined a circuitized substrate including a composite layer comprising a first dielectric sub-layer comprised of a halogen-free resin and fibers dispersed therein and a second dielectric sub-layer without fibers but also including a halogen-free resin with inorganic particulates therein. A method of making such a substrate is also provided, as is a multilayered assembly including one or more such circuitized substrates, possibly in combination with other substrates. An information handling system designed for having one or more such circuitized substrates is also provided.

The present application is a continuation-in-part application of Ser. No. 11/352,279, which in turn is a continuation-in-part application of Ser. No. 11/172,794, which in turn is a continuation-in-part application of Ser. No. 11/031,085.

All of the above applications, including the one with the patent which have issued there-from, are assigned to the same assignee as the present invention.

### BACKGROUND OF THE INVENTION

Circuitized substrates such as printed circuit boards (hereinafter also referred to as PCBs), chip carriers, and the like are typically produced in laminate form in which several layered dielectric and conductive material members (laminates) are bonded together using conventional lamination processing involving relatively high temperatures and pressures. The conductive layers, typically of thin copper, are usually used in the formed substrate for providing electrical connections to and among various devices located on the surface of the substrate, examples of such devices being integrated circuits (semiconductor chips) and discrete passive devices, such as capacitors, resistors, inductors, and the like. Typically, these discrete passive devices occupy a high percentage of the surface area of the completed multi-layered substrate, which is obviously undesirable from a future design perspective due to the ever-present demand for miniaturization.

In order to increase the available substrate surface area (also often referred to as “real estate”) of such substrates, there have been a variety of efforts to include multiple functions (e.g. resistors, capacitors and the like) on a single component for mounting on a board. When passive devices are in such a configuration, these are often referred to collectively and individually as integral passive devices or the like, meaning that the functions are integrated into the singular component. Because of such external positioning, these components still utilize, albeit less than if in singular form, valuable board “real estate.” In response, there have been efforts to embed discrete passive components within the board, such components often also referred to as embedded passive components. A capacitor designed for disposition within (between selected layers of) a PCB (board) substrate may thus be referred to as an embedded integral passive component, or, more simply, an embedded capacitor. Such a capacitor thus provides internal capacitance. The result of this internal positioning is that it is unnecessary to also position such devices externally on the PCB's outer surface(s), thus saving valuable PCB real estate.

For an established capacitor area, two approaches are known for increasing the planar capacitance (capacitance/area) of an internal capacitor. In one such approach, higher dielectric constant materials can be used, while in a second, the thickness of the dielectric can be reduced. These constraints are reflected in the following formula, known in the art, for capacitance per area:
C/A=(Dielectric Constant of Laminate×Dielectric Constant in Vacuum/Dielectric Thickness)
where: C is the capacitance and A is the capacitor's area. Some of the patents listed below, and some of the pending applications cited above, mention the use of various materials for providing desired capacitance levels under this formula. With respect to the following patents, many mention or suggest problems associated with the methods and resulting materials used to do so.

As mentioned above, there have been previous attempts to provide internal capacitance and other internal conductive structures, components or devices (one good example being internal semiconductor chips) within circuitized substrates such as PCBs, some of these including the use of nano-powders. The cited applications Ser. No. 11,031,085 and Ser. No. 11/172,794 also define such approaches. The following are some further examples of such attempts, including some which discuss using nano-powders and those using alternative measures.

In U.S. Pat. No. 7,064,412, there is described an electronic package including a conductive trace layer having a first side and a second side. The conductive trace layer is patterned to define a plurality of interconnect pads. A flexible dielectric substrate is mounted on the first side of the conductive trace layer. A flexible capacitor including a first conductive layer, a second conductive layer and a layer of dielectric material disposed between the first and the second conductive layers is mounted with the first conductive layer adjacent the second side of the conductive trace layer. A plurality of interconnect regions extend through the first conductive layer and the dielectric material layer of the capacitor. An interconnect member is connected between each one of the conductive layers of the capacitor and a corresponding set of the interconnect pads. The first conductive layer of the capacitor is electrically connected to a first set of the interconnect pads and the second conductive layer of the capacitor is electrically connected to a second set of the interconnect pads. The interconnect members corresponding to the second set of interconnect pads extend through one of the interconnect regions. An aperture extends through the dielectric substrate adjacent to each one of the interconnect pads. A stiffening member is mounted adjacent the second conductive layer of the capacitor. A device receiving region is formed through the dielectric substrate, the conductive trace layer and the capacitor. In this patent, a copper foil, or other conductive substrate, which may have material present on its surface such as an organic anti-corrosion agent (for example, a benzotriazole derivative) and residual oils from a rolling process, preferably, has a thickness of less than about 100 microns. The copper foil is subjected to a surface treatment to ensure adhesion between the dielectric layer and layers of copper foil. Removal can be effected by, for example, treating the foil with an argon-oxygen plasma, an air corona, or a wet chemical treatment. A blend of dielectric material may be prepared by providing a resin such as epoxy, optionally including dielectric or insulating particles such as barium titanate, and optionally including a catalyst for the epoxy. Absorbed water or residual materials on the particles, e.g., carbonates resulting from the manufacturing process, can be removed from the surface of the particles before use by heating the particles in air at a particular temperature for a period of time, for example, 350 degrees Celsius (also referred to herein at many locations simply as C) for fifteen hours. The blend of barium titanate particles and epoxy is prepared by mixing together barium titanate, a solvent solution of epoxies, e.g. ketone, and a dispersing agent. A high shear rotor-stator mixer (6000 rpm) with a water/ice bath is used, while ball-milling is another method. The blend is allowed to sit undisturbed allowing agglomerates to settle to the bottom of the container. The settling is allowed to occur for about twelve hours or more. As a final filtration step, the blend is then filtered, for example, through a stainless steel mesh filter or equivalent having a mesh size of from about two micrometers to about five micrometers. The blend may be coated onto the copper in a solvent system or solvent may be omitted if the organic binder is a liquid with sufficiently low viscosity to enable coating.

In U.S. Pat. No. 6,815,085, there is described a capacitive element for a circuit board or chip carrier which is formed from a pair of conductive sheets having a dielectric component laminated there-between. The dielectric component is formed from two or more dielectric sheets, at least one of which can be partially cured followed by being fully cured. The partially cured sheet is laminated to at least one other sheet of dielectric material and one of the sheets of conductive material. The total thickness of the two sheets of the dielectric component does not exceed about four mils and preferably does not exceed about three mils. The use of two or more sheets of dielectric material makes it very unlikely that two or more defects in the sheets of dielectric material will align, thus greatly reducing the probability of a defect causing a failure in test or field use. In this patent, a pair of copper sheets are coated each on one side thereof with a dielectric material which may be epoxy or other type of dielectric material such as a cyanate ester, a polyimide, or polytetrafluoroethlyene (PTFE). The dielectric materials, other than the impregnated glass cloth, may be applied as liquids or, in the case of polyimide and PTFE, be in the form of free standing films of material. The material is partially cured or, in the case of films or glass cloth, may be applied to the copper in the partially cured form. The sheets of copper with the dielectric material thereon are laminated together to form a structure comprised of two sheets of copper separated by two sheets of fully cured dielectric material

In U.S. Pat. No. 6,739,027, there is described a method for producing a capacitor to be embedded in an electronic circuit package comprising the steps of selecting a first conductor foil, selecting a dielectric material, coating the dielectric material on at least one side of the first conductor foil, and layering the coated foil with a second conductor foil on top of the coating of dielectric material. Also claimed is an electronic circuit package incorporating at least one embedded capacitor manufactured in accordance with the present invention. In this patent, pre-drilled or pre-etched copper conductor foils that have been coated with a dielectric material are in the form of voltage or ground planes. After coating with dielectric material, these are stacked up in alternate fashion (i.e. voltage/ground/voltage) and laminated together with other signal planes to create a final multi-layer circuit board. Other suitable conductor foils include copper-Invar-copper, Invar, aluminum, and copper pre-laminated to a dielectric. The dielectric coating may be standard liquid epoxy, polyimide, Teflon, cyanate resins, powdered resin materials, or filled resin systems exhibiting enhanced dielectric constants. Coating of the dielectric material onto the copper foil may be performed using roller, draw, powder or curtain coating, electrostatic or electrophoretic deposition, screen printing, spraying, dipping or transfer of a dry film. Once multi-layer laminated, the thickness of these coated films is not limited by a glass cloth material.

In U.S. Pat. No. 6,704,207, there is described a printed circuit board (PCB) which includes a first layer having first and second surfaces, with an above-board device (e.g., an ASIC chip) mounted thereon. The PCB includes a second layer having third and fourth surfaces. One of the surfaces can include a recessed portion for securely holding an interstitial component. A “via”, electrically connecting the PCB layers, is also coupled to a lead of the interstitial component. The described interstitial components include components such as diodes, transistors, resistors, capacitors, thermocouples, and the like. In what appears to be the preferred embodiment, the interstitial component is a resistor having a similar size to a “0402” resistor (manufactured by Rohm Co.), which has a thickness of about 0.014 inches.

In U.S. Pat. No. 6,638,378, there is described a passive electrical article comprising (a) a first self-supporting substrate having two opposing major surfaces, (b) a second self-supporting substrate having two opposing major surfaces, and (c) an electrically insulating or electrically conducting layer comprising a polymer and having a thickness ranging from about 0.5 to about 10 microns between the first and second substrate, wherein a major surface of the first substrate in contact with the layer and a major surface of the second substrate in contact with the layer have an average surface roughness ranging from about ten to about 300 nm and wherein a force required to separate the first and second substrates of the passive electrical article at a ninety degree peel angle is greater than about three pounds/inch (about 0.5 kN/m). Suitable resins for the electrically insulating or electrically conductive layer, which can be used to form a capacitor or a resistor, include epoxy, polyimide, polyvinylidene fluoride, benzocyclobutene, polynorbornene, polytetrafluoroethylene, acrylates, and blends thereof. Commercially available epoxies include those available from Shell Chemical Company, Houston, Tex., under the trade designation “Epon 1001F” and “Epon 1050.” Preferably, the resin can withstand a temperature that would be encountered in a typical solder reflow operation, for example, in the range of about 180 to about 290 degrees C. These resins may be dried or cured to form the electrically insulating or electrically conducting layer. Dielectric or insulating particles include barium titanate, barium strontium titanate, titanium oxide, lead zirconium titanate, and mixtures thereof. A commercially available barium titanate is available from Cabot Performance Materials, Boyertown, Pa., under the trade designation “BT-8”. Conductive particles may comprise conductive or semiconductive materials such as metal or metal alloy particles where the metal may be silver, nickel, or gold; nickel-coated polymer spheres; gold-coated polymer spheres (commercially available from JCI USA Inc., New York, N.Y., under product designation number “20 GNR4.6-EH”); graphite tantalum nitrides; tantalum oxynitride; doped silicon; silicon carbide; and metal silicon nitrides.

In U.S. Pat. No. 6,625,857, there is described a method of forming a capacitive element for a circuit board or chip carrier. The element is formed from a pair of conductive sheets having a dielectric component laminated there-between. The dielectric component is formed of two or more dielectric sheets, at least one of which can be partially cured followed by being fully cured. The lamination takes place by laminating a partially cured sheet to at least one other sheet of dielectric material and one of the conductive sheets. The total thickness of the two sheets of the dielectric component does not exceed about four mils and preferably does not exceed about three mils; thus, the single dielectric sheet does not exceed about two mils and preferably does not exceed about 1.5 mils. The conducting sheets are preferably copper, e.g., either 0.5 ounce or 1.0 ounce copper sheets, available from Gould Corp. The sheets preferably have one surface roughened to improve adhesion to other materials. A pair of dielectric material sheets are provided and located between the copper sheets. The dielectric sheets are ultra thin sheets of glass cloth which have been impregnated with an epoxy and partially (B-stage) cured. This B-stage curing is accomplished by heating to about 100 degrees C. for five to twenty minutes. The epoxy resin may be phenolically hardened epoxy resin. Glass cloths impregnated with this type of resin are sold by the assignee of this invention under the registered trademark Driclad.

In U.S. Pat. No. 6,616,794, there is described a method for producing integral capacitance components for inclusion within printed circuit boards in which hydro-thermally prepared nano-powders permit the fabrication of dielectric layers that offer increased dielectric constants and are readily penetrated by micro-vias. In the method described in this patent, a slurry or suspension of a hydro-thermally prepared nano-powder and solvent is prepared. A suitable bonding material, such as a polymer, is mixed with the nano-powder slurry, to generate a composite mixture which is formed into a dielectric layer. The dielectric layer may be placed upon a conductive layer prior to curing, or conductive layers may be applied upon a cured dielectric layer, either by lamination or metallization processes, such as vapor deposition or sputtering.

In U.S. Pat. No. 6,574,090, there is described a capacitive element for a circuit board or chip carrier and method of manufacturing the same. The structure is formed from a pair of copper sheets having a dielectric component laminated there-between. The dielectric component, e.g., resin-impregnated fiber glass (one example being a material sold under the trade name “Driclad”, by the then trademark owner, IBM, said trademark now owned by the assignee of this invention as stated above.) is formed of two or more dielectric sheets, at least one of which can be partially cured or softened followed by being fully cured or hardened. The lamination takes place by laminating a partially cured or softened sheet to at least one other sheet of dielectric material and one of the sheets of conductive material. The total thickness of the two sheets of the dielectric component does not exceed about four mils and preferably does not exceed about three mils; thus, the single dielectric sheet does not exceed about two mils and preferably does not exceed about 1.5 mils in thickness.

In U.S. Pat. No. 6,542,379, there are described passive electrical components such as capacitors, resistors, inductors, transformers, filters and resonators which are integrated into electrical circuits utilizing a process which maximizes the utilization of the planar surfaces of the substrates for high density placement of active components such as logic or memory integrated circuits. The passive components are integrated into a conventional circuit board utilizing a photoimageable dielectric material. The dielectric is photoimaged and etched to provide one or more recesses or openings for the passive devices, and photo-vias interconnecting the inputs and outputs of the integrated circuit board. The electronic structure comprising at least one of the passive devices integrated into a photoimaged dielectric is described as well as the method of manufacturing the same.

In U.S. Pat. No. 6,524,352, there is defined a parallel capacitor structure capable of forming an internal part of a larger circuit board or the like structure to provide capacitance therefore. Alternatively, the capacitor may be used as an inter-connector to interconnect two different electronic components (e.g., chip carriers, circuit boards, and semiconductor chips) while still providing desired levels of capacitance for one or more of said components. The capacitor includes at least one internal conductive layer, two additional conductor layers added on opposite sides of the internal conductor, and inorganic dielectric material (preferably an oxide layer on the second conductor layer's outer surfaces or a suitable dielectric material such as barium titanate applied to the second conductor layers). Further, the capacitor includes outer conductor layers atop the inorganic dielectric material, thus forming a parallel capacitor between the internal and added conductive layers and the outer conductors.

In U.S. Pat. No. 6,496,356, there is described a method of forming a capacitive core structure and of forming a circuitized printed wiring board from the core structure. The capacitive core structure is formed by providing a central conducting plane of a sheet of conductive material and forming at least one clearance hole in the central conducting plane. First and second external conducting planes are laminated to opposite sides of the ground plane with a film of dielectric material between each of the first and second external planes and the central conducting plane. At least one clearance hole is formed in each of the first and second external planes. A circuitized wiring board structure can be formed by laminating a capacitive core structure between two circuitized structures.

In U.S. Pat. No. 6,446,317, there is described a hybrid capacitor associated with an integrated circuit package that provides multiple levels of excess, off-chip capacitance to die loads. The hybrid capacitor includes a low inductance, parallel plate capacitor which is embedded within the package and electrically connected to a second source of off-chip capacitance. The parallel plate capacitor is disposed underneath a die, and includes a top conductive layer, a bottom conductive layer, and a thin dielectric layer that electrically isolates the top and bottom layers. The second source of off-chip capacitance is a set of self-aligned via capacitors, and/or one or more discrete capacitors, and/or an additional parallel plate capacitor. Each of the self-aligned via capacitors is embedded within the package, and has an inner conductor and an outer conductor. The inner conductor is electrically connected to either the top or bottom conductive layer, and the outer conductor is electrically connected to the other conductive layer. The discrete capacitors are electrically connected to contacts from the conductive layers to the surface of the package. During operation, one of the conductive layers of the low inductance parallel plate capacitor provides a ground plane, while the other conductive layer provides a power plane.

In U.S. Pat. No. 6,395,996, there is described a multi-layered substrate having built-in capacitors which are used to decouple high frequency noise generated by voltage fluctuations between a power plane and a ground plane of a multi-layered substrate. At least one kind of dielectric material, which has filled-in through holes between the power plane and the ground plane and includes a high dielectric constant, is used to form the built-in capacitors.

In U.S. Pat. No. 6,370,012, there is described a parallel capacitor structure capable of forming an internal part of a larger circuit board or the like structure to provide capacitance there-for. Alternatively, the capacitor may be used as an inter-connector to interconnect two different electronic components (e.g., chip carriers, circuit boards, and even semiconductor chips) while still providing desired levels of capacitance for one or more of said components. The capacitor includes at least one internal conductive layer, two additional conductor layers added on opposite sides of the internal conductor, and inorganic dielectric material (preferably an oxide layer on the second conductor layer's outer surfaces or a suitable dielectric material such as barium titanate applied to the second conductor layers). Further, the capacitor includes outer conductor layers atop the inorganic dielectric material, thus forming a parallel capacitor between the internal and added conductive layers and the outer conductors.

In U.S. Pat. No. 6,343,001, there is described a method of forming a capacitive core structure and of forming a circuitized printed wiring board from the core structure. The capacitive core structure is formed by providing a central conducting plane of a sheet of conductive material and forming at least one clearance hole in the central conducting plane. First and second external conducting planes are laminated to opposite sides of the ground plane with a film of dielectric material between each of the first and second external planes and the central conducting plane. At least one clearance hole is formed in each of the first and second external planes. A circuitized wiring board structure can be formed by laminating a capacitive core structure between two circuitized structures.

In U.S. Pat. No. 6,274,224, there is described a passive electrical article comprising (a) a first self-supporting substrate having two opposing major surfaces, (b) a second self-supporting substrate having two opposing major surfaces, and (c) an electrically insulating or electrically conducting layer, wherein a major surface of the first substrate in contact with the layer and a major surface of the second substrate in contact with the layer have an average surface roughness ranging from about 10 to about 300 nm and wherein a force required to separate the first and second substrates of the passive electrical article at a ninety degree peel angle is greater than about three pounds/inch (about 0.5 kN/m). Dielectric materials possessing higher dielectric constants are used, as may be alternative perovskite class materials such as barium titanate (BaTiO₃), lead-zirconium titanate (PZT), lead-manganese-niobium (PMN), lead titanate (PbTiO₃) and strontium titanate (SrTiO₃). Copper is used for the conductive layering.

In U.S. Pat. No. 6,256,850, there is described a method for producing a capacitor to be embedded in an electronic circuit package comprising the steps of selecting a first conductor foil, selecting a dielectric material, coating the dielectric material on at least one side of the first conductor foil, and layering the coated foil with a second conductor foil on top of the coating of dielectric material. The conductor foil is copper, with other suitable conductor foils including copper-Invar-copper, Invar, aluminum, and copper pre-laminated to a dielectric. The dielectric coating may be any type of dielectric material from standard liquid epoxy, polyimide, Teflon, cyanate resins, powdered resin materials, or filled resin systems exhibiting enhanced dielectric constants. Coating of the dielectric material onto the conductor foil is performed with any number of methods known in the industry such as roller, draw, powder or curtain coating, electrostatic or electrophoretic deposition, screen printing, spraying, dipping or transfer of a dry film.

In U.S. Pat. No. 6,215,649, there is described a capacitive element for a circuit board or chip carrier. The structure is formed from a pair of conductive sheets having a dielectric component laminated there-between. The dielectric component is formed of two or more dielectric sheets at least one of which can be partially cured or softened followed by being fully cured or hardened. The lamination takes place by laminating a partially cured or softened sheet to at least one other sheet of dielectric material and one of the sheets of conductive material. The use of two or more sheets of dielectric material is alleged in this patent to make it unlikely that two or more defects in the sheets of dielectric material will align, thus greatly reducing the probability of a defect causing a failure in test or field use.

In U.S. Pat. No. 6,207,595, there is described a fabric-resin dielectric material for use in a laminate structure and method of its manufacture. The resulting structure is adaptable for use in a printed circuit board or chip carrier substrate. The resin may be an epoxy resin such as is currently used on a large scale worldwide for “FR-4” composites. A resin material based on bismaleimide-triazine (BT) is also acceptable, this patent further adding that, more preferably, the resin is a phenolically hardenable resin material as is known in the art, with a glass transition temperature of about 145 degrees C.

In U.S. Pat. No. 6,150,456, there is described a flexible, high dielectric constant polyimide film composed of either a single layer of an adhesive thermoplastic polyimide film or a multilayer polyimide film having adhesive thermoplastic polyimide film layers bonded to one or both sides of the film and having dispersed in at least one of the polyimide layers from 4 to 85 weight % of a ferroelectric ceramic filler, such as barium titanate or polyimide-coated barium titanate, and having a dielectric constant of from 4 to 60. The high dielectric constant polyimide film can be used in electronic circuitry and electronic components such as multilayer printed circuits, flexible circuits, semiconductor packaging and buried (internal) film capacitors.

In U.S. Pat. No. 6,068,782, there is described a method of fabricating individual, embedded capacitors in multilayer printed circuit boards. The method is allegedly compatible of being performed using standard printed circuit board fabrication techniques. The capacitor fabrication is based on a sequential build-up technology employing a first pattern-able insulator. After patterning of the insulator, pattern grooves are filled with a high dielectric constant material, typically a polymer/ceramic composite. Capacitance values are defined by the pattern size, thickness and dielectric constant of the composite. Capacitor electrodes and other electrical circuitry can be created either by etching laminated copper, by metal evaporation or by depositing conductive ink.

In U.S. Pat. No. 5,972,053, there is described a process for manufacturing a multi- layer printed circuit board utilizing layers including Ta and Hf and various other elements including Ta and Hf as part thereof for the board's layers. A capacitor may also be formed using this approach, according to the authors of this patent.

In U.S. Pat. No. 5,796,587, there is described a method for producing a capacitor to be embedded in an electronic circuit package comprising the steps of selecting a first conductor foil, selecting a dielectric material, coating the dielectric material on at least one side of the first conductor foil, and layering the coated foil with a second conductor foil on top of the coating of dielectric material.

In U.S. Pat. No. 5,162,977, there is described a PCB which includes a high capacitance power distribution core, the manufacture of which is compatible with standard printed circuit board assembly technology. The high capacitance core consists of a ground plane and a power plane separated by a planar element having a high dielectric constant. The high dielectric constant material is typically glass fiber impregnated with a bonding material, such as epoxy resin loaded with a ferro-electric ceramic substance having a high dielectric constant. The ferro-electric ceramic substance is typically a nano-powder combined with an epoxy bonding material. According to this patent, the resulting capacitance of the power distribution core is sufficient to totally eliminate the need for decoupling capacitors on a PCB.

In U.S. Pat. No. 5,079,069, there is described a capacitor laminate which allegedly serves to provide a bypass capacitive function for devices mounted on the PCB, the capacitor laminate being formed of conventional conductive and dielectric layers whereby each individual external device is allegedly provided with capacitance by a proportional portion of the capacitor laminate and by borrowed capacitance from other portions of the capacitor laminate, the capacitive function of the capacitor laminate being dependent upon random firing or operation of the devices. That is, the resulting PCB still requires the utilization of external devices thereon, and thus does not afford the PCB external surface area real estate savings mentioned above which are desired and demanded in today's technology.

In U.S. Pat. No. 5,027,253, there is described a multilayer circuit package having a “buried” thin film capacitor. The circuit package includes at least a power core, a ground core, a first signal core, a second signal core, and the integral, buried, thin film capacitor. The integral, buried, thin film capacitor serves to capacitively couple the first and second signal cores. Structurally, the first signal core includes at least one first wire that terminates in at least one first electrode, while the second signal core includes at least one second wire that terminates in at least one second electrode. At least a portion of the first electrode overlays at least a portion of the first electrode overlays at least a portion of the second electrode and is separated there-from by a thin film of a dielectric material. The first electrode, the second electrode, and the thin film of dielectric material define the integral buried capacitor. The thin film capacitor is prepared by thin film methodology, with epitaxial deposition of the dielectric

In U.S. Pat. No. 4,945,399, there is described a semiconductor chip carrier which includes a plurality of distributed high frequency decoupling capacitors as an integral part of the carrier. The distributed capacitors are formed as a part of the first and second layers of metallurgy and separated by a layer of thin film dielectric material built up on a substrate. The distributed capacitors are positioned to extend from a ground pin of one of the layers of metallurgy to a plurality of mounting pads which are integral parts of the other of the layers of metallurgy. A semiconductor chip is mounted to the mounting pads and receives electrical power and signals there-through. The distributed capacitors decrease electrical noise associated with simultaneous switching of relatively large numbers of off-chip drivers which are electrically connected to the semiconductor chip.

Circuitized substrate manufacturers, in addition to requiring decreasing line widths and thru-hole diameters in order to provide even greater circuit densities, also must avoid manufacturing problems frequently associated with their products. For example, some current processes utilize inner-layer materials that are typically glass-reinforced resin or other suitable dielectric material layers having a thickness of from about two to five mils, clad with metal (typically copper) on both surfaces. Glass-reinforcing material, typically utilizing continuous strands of fiberglass which extend throughout the width and length of the overall final substrates, is used to contribute strength and rigidity to the final stack. Being continuous, these strands commonly run the full width (or length) of the structure and include no breaks or other segments as part thereof. Such fibrous materials occupy a relatively significant portion of the substrate's total volume, a disadvantage especially when attempting to produce highly dense numbers of thru-holes and very fine line circuitry to meet new, more stringent design requirements. More specifically, when holes are drilled (typically using laser or mechanical drills) to form these needed thru-holes, end segments of the fiberglass fibers may extend into the holes during lamination, and, if so, must be removed prior to metallization. This removal, in turn, creates the need for additional pretreatment steps such as the use of glass etchants to remove the glass fibrils extending into the holes, subsequent rinsing, etc. If the glass is not removed, a loss of continuity might occur in the internal wall metal deposit. In addition, both continuous and semi-continuous glass fibers add weight and thickness to the overall final structure, yet another disadvantage associated with such fibers. Additionally, since lamination is typically at a temperature above 150 degrees C., the resinous portion of the laminate usually shrinks during cooling to the extent permitted by the rigid copper cladding, which is not the case for the continuous strands of fiberglass or other continuous reinforcing material used. The strands thus take on a larger portion of the substrate's volume following such shrinkage and add further to complexity of manufacture in a high-density product. If the copper is etched to form a discontinuous pattern, laminate shrinkage may not be restrained even to the extent above by the copper cladding. Obviously, this problem is exacerbated as feature sizes (line widths and thicknesses, and thru-hole diameters) decrease. Consequently, even further shrinkage may occur. The shrinkage, possibly in part due to the presence of the relatively large volume percentage of continuous or semi-continuous fiber strands in the individual layers used to form a final product possessing many such layers, may have an adverse affect on dimensional stability and registration between said layers, adding even more problems for the PCB manufacturer.

Glass fiber presence, especially woven glass fibers, also substantially impairs the ability to form high quality, very small thru-holes using a laser. Glass cloth has drastically different absorption and heat of ablation properties than typical thermoset or thermoplastic matrix resins. In a typical woven glass cloth, for example, the density of glass a laser might encounter can vary from approximately 0% in a window area to approximately 50% by volume or even more, especially in an area over a cloth “knuckle”. This wide variation in encountered glass density leads to problems obtaining the proper laser power for each thru-hole and may result in wide variations in thru-hole quality, obviously unacceptable by today's very demanding manufacturing standards. Glass fiber presence also often contributes to an electrical failure mode known as CAF growth. CAF (cathodic/anodic filament) growth often results in an electrical shorting failure which occurs when dendritic metal filaments grow along an interface (typically a glass fiber/epoxy resin interface), creating an electrical path between two features which should remain electrically isolated. Whether continuous (like woven cloth) or semi-continuous (like chopped fiber mattes), glass fiber lengths are substantial in comparison to the common distances between isolated internal features, and thus glass fibers can be a significant detractor for PCB insulation resistance reliability. While the use of glass mattes composed of random discontinuous chopped fibers (in comparison to the longer fibers found in continuous structures) can largely abate the problem of inadequate laser drilled thru-hole quality, such mattes still contain fibers with substantial length compared to internal board feature spacing and, in some cases, offer virtually no relief from the problem of this highly undesirable type of growth.

Use of pre-fired and ground ceramic powders in the dielectric layer, including as substitutes for the above glass fibers, also generally poses obstacles for the formation of thru-holes between conductive layers of a PCB. Pre-fired and ground ceramic nano-powder particles have a typical dimension in the range of 500-20,000 nanometers (nm). Furthermore, the particle distribution in this range is generally rather broad, meaning that there could be a 10,000 nm particle alongside a 500 nm particle. The distribution within the dielectric layer of particles of different size often presents obstacles to thru-hole formation where the thru-holes are of extremely small diameter, also referred to in the industry as micro-vias. Another problem associated with pre-fired ceramic nano-powders is the ability for the dielectric layer to withstand substantial voltage without breakdown occurring across the layer. Typically, capacitance layers within a PCB are expected to withstand at least 300 volts (V) in order to qualify as a reliable component for PCB construction. The presence of the comparatively larger ceramic particles in pre-fired ceramic nano-powders within a capacitance layer prevents extremely thin layers from being used because the boundaries of contiguous large particles provide a path for voltage breakdown. This is even further undesirable because, as indicated by the equation cited above, greater planar capacitance may also be achieved by reducing the thickness of the dielectric layer. The thickness is thus limited by the size of the particles therein.

Generally speaking, with respect to commercially available dielectric powders which have been used in internal conductive structures such as mentioned in some of the above patents, among these being metal titanate-based powders (see, e.g., U.S. Pat. No. 6,150,456), such powders are known to be produced by a high-temperature, solid-state reaction of a mixture of the appropriate stoichiometric amounts of oxides or oxide precursors (e.g., carbonates, hydroxides or nitrates) of barium, calcium, titanium, and the like. In such calcination processes, the reactants are wet-milled to accomplish a desired final mixture. The resulting slurry is dried and fired at elevated temperatures, sometimes as high as 1,300 degrees C., to attain the desired solid state reactions. Thereafter, the fired product is milled to produce a powder. Although the pre-fired and ground dielectric formulations produced by solid phase reactions are acceptable for many electrical applications, these suffer from several disadvantages. First, the milling step serves as a source of contaminants, which can adversely affect electrical properties. Second, the milled product consists of irregularly shaped fractured aggregates which are often too large in size and possess a wide particle size distribution, 500-20,000 nm. Consequently, films produced using these powders are limited to thicknesses greater than the size of the largest particle. Thirdly, powder suspensions or composites produced using pre-fired ground ceramic powders typically must be used immediately after dispersion, due to the high sedimentation rates associated with large particles. The stable crystalline phase of barium titanate for particles greater than 200 nm is tetragonal and, at elevated temperatures, a large increase in dielectric constant occurs due to a phase transition. It is thus clear that methods of making PCBs which rely on the advantageous features of using nano-powders as part of the PCB's internal components or the like, such as those described in selected ones of the above patents, possess various undesirable aspects which are detrimental to providing a PCB with optimal functioning capabilities when it comes to internal capacitance or other electrical operation. This is particularly true when the desired final product attempts to meet today's miniaturization demands, including the utilization of high density patterns of thru-holes therein.

As defined herein, the present invention represents a capacitor material which is capable of being applied to a suitable conductor substrate and thereafter exhibiting substantially non-flaking characteristics, thus greatly facilitating subsequent processing thereof. A flake free capacitor member further assures that the exact amount of capacitor material remains in place during such processing and thus in the final structure, thereby assuring that precisely defined properties (especially final capacitance) will result from the eventually formed structure using same. It has been learned, quite surprisingly, that a capacitor material with this property can be formed and used successfully without the need for fibers as part thereof, thus overcoming the above identified deleterious problems associated with same. Of even further evidence of non-obviousness, it has been learned that said material may also be formed and used absent the problems associated with particle inclusion, as also cited above, while including particles as part thereof. It is believed that such a material, as well as a capacitive substrate including a capacitor with such material as part thereof will represent significant advancements in the art. It is further believed that a method of making a capacitive member adapted for use in such a substrate will also constitute a significant advancement in the art.

### OBJECTS AND SUMMARY OF THE INVENTION

It is, therefore, a primary object of the present invention to enhance the circuitized substrate art by providing a new and unique capacitor material and a capacitor member including such material as part thereof.

It is another object of the invention to provide a method of making such a capacitor member which can be accomplished in a relatively facile manner and at relatively low costs.

According to one aspect of the invention, there is provided a capacitor material comprising a thermosetting resin, a high molecular mass flexibilizer, and a quantity of nano-particles of a ferroelectric ceramic material, the capacitor material not including continuous or semi-continuous fibers as part thereof and being adapted for being positioned in layer form on a first conductor member and heated to a predetermined temperature whereupon the material will not possess any substantial flaking characteristics, and thereafter adapted for having a second conductor member positioned thereon to form a capacitor member.

According to another aspect of the invention, there is provided a capacitive substrate comprising a plurality of dielectric layers and a plurality of conductor layers and an internal capacitor positioned within the capacitive substrate. The internal capacitor includes a first conductor member, a capacitor material positioned on this first conductor member and comprised of a thermosetting resin, a high molecular mass flexibilizer, and a quantity of nano-particles of a ferroelectric ceramic material, this capacitor material not including continuous or semi-continuous fibers as part thereof and being adapted for being positioned in layer form on a first conductor member and heated to a predetermined temperature whereupon the material will not possess any substantial flaking characteristics. The internal capacitor further includes a second conductor member positioned on the capacitor material.

According to yet another aspect of the invention, there is provided a method of making a capacitor member for use within a capacitive substrate, this method comprising providing a first conductor member, positioning a quantity of capacitor material on the first conductor member, the quantity of capacitor material including a thermosetting resin, a high molecular mass flexibilizer, and a quantity of nano-particles of a ferroelectric ceramic material but not including continuous or semi-continuous fibers as part thereof, heating the quantity of capacitor material on the first conductor member to a predetermined temperature for a predetermined time period such that the capacitor material will not possess any substantial flaking characteristics, and thereafter positioning a second conductor member on the quantity of capacitor material.

### BRIEF DESCRIPTION OF THE DRAWINGS

FIGS. 1 and 2 are side elevational views, in section and on an enlarged scale, illustrating the steps of making a capacitor member in accordance with one embodiment of the invention;

FIG. 3 is a side elevational view, in section and on an enlarged scale, illustrating the initial steps of making a capacitive substrate in accordance with one embodiment of the invention, this substrate utilizing the capacitor of FIG. 2;

FIG. 4 is a side elevational view, in section and on an enlarged scale, illustrating the capacitive substrate of FIG. 3, after having been subjected to further processing, including one example of an electrical component positioned thereon and one example of a substrate on which the capacitive substrate may be positioned if designed as in FIG. 4; and

FIG. 5 is a side elevational view, in section and on an enlarged scale over the view of FIG. 3, illustrating an alternative embodiment of a capacitive substrate of the invention.

### BEST MODE OF CARRYING OUT THE INVENTION

For a better understanding of the present invention, together with other and further objects, advantages and capabilities thereof, reference is made to the following disclosure and appended claims in connection with the above-described drawings. Like figure numbers may be used from FIG. 1 to FIG. 5 to identify like elements in these drawings.

By the term “capacitive substrate” as used herein is meant a substrate including at least one capacitor member therein. Such substrates, in simplest form, are adapted for being used as a substrate having other electrical components electrically coupled thereto, e.g., to form an electrical assembly. The capacitive substrates as formed in accordance with the teachings herein may be incorporated with other similar such substrates within a larger substrate structure, including possibly other dielectric and conductor layers as part thereof, to form a larger, multilayered substrate such that the capacitive substrates form internal members within of this larger circuitized substrate. Unlike the capacitor material of the internal capacitors, the dielectric materials for such other dielectric layers may comprise fiberglass-reinforced epoxy resins (some referred to as “FR-4” dielectric materials in the art), polytetrafluoroethylene (Teflon), polyimides, polyamides, cyanate resins, photo-imageable materials, and other like materials. Examples of conductive materials for use as such conductor layers include copper and copper alloy, but other metals may be used. As understood, such conductor layers may also be used as part of the capacitor members of this invention.

By the term “capacitor member” as used herein is meant a member comprising at least two conductor layers and an interim quantity of capacitor material, said capacitor member adapted for being positioned within and thus part of a capacitive substrate.

By the term “continuous” as used herein to define fibrous materials is meant a structure such as a woven cloth including lengthy fibers, including fibers which run the full distance through the structure. By the term “semi-continuous” as used herein to define fibrous materials is meant structures with much shortened length fibers, which are also referred to as “chopped” fibers, one example being chopped fiber mats.

By the term “electrical component” as used herein is meant components such as semiconductor chips and the like which are adapted for being positioned on the external conductive surfaces of substrates and electrically coupled to the substrate for passing signals from the component into the substrate where upon such signals may be passed on to other components, including those mounted also on the substrate, as well as other components such as those of a larger electrical system in which the substrate is positioned.

By the term “electrical assembly” is meant at least one capacitive substrate as defined herein in combination with at least one electrical component electrically coupled thereto and forming part of the assembly. Examples of known such assemblies include chip carriers which include a semiconductor chip as the electrical component, the chip usually positioned on the substrate and coupled to wiring (e.g., pads) on the substrate's outer surface or to internal conductors using one or more thru-holes. Perhaps the most well known such assembly is the conventional printed circuit board (PCB) typically having several external components such as chip carriers, semiconductor chips, etc. mounted thereon and coupled to the internal circuitry of the PCB.

By the term “ferroelectric ceramic” as used herein is meant ceramics that possess ferroelectric properties. These include barium titanate, substituted barium titanate, strontium titanate, lead titanate, lead zirconate titanate, substituted lead zirconate titanate, lead magnesium niobate, lead zinc niobate, lead iron niobate, solid solutions of lead magnesium niobate and lead titanate, solid solutions of lead zinc niobate and lead titanate, lead iron tantalite, other ferroelectric tantalates, and combinations or mixtures thereof.

By the term “high molecular mass” as used herein to define the flexibilizers used in the capacitor material compositions herein is meant a molecular mass of at least 4,000 grams/mole.

By the term “information handling system” as used herein shall mean any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as servers, mainframes, etc. Such systems typically include one or more PCBs, chip carriers, etc. as integral parts thereof. For example, a PCB typically used includes a plurality of various components such as chip carriers, capacitors, resistors, modules, etc. mounted thereon. One such PCB may be referred to as a “motherboard” while various other boards (or cards) may be mounted thereon using suitable electrical connectors.

By the term “nano-particles” is meant particles with a size of from about 0.01 micron (ten nanometers) to about one micron (1000 nanometers). The capacitor material powders used to form the capacitor members herein are understood to include “nano-particles.”

By the term “thru-hole” as used herein is meant to include what are also commonly referred to in the industry as “blind vias” which are openings typically from one surface of a substrate to a predetermined distance therein, “internal vias” which are vias or openings located internally of the substrate and are typically formed within one or more internal layers prior to lamination thereof to other layers to form the ultimate structure, and “plated through holes” (also known as PTHS), which typically extend through the entire thickness of a substrate. All of these various openings form electrical paths through the substrate and often include one or more conductive layers, e.g., plated copper, thereon. Alternatively, such openings may simply include a quantity of conductive paste or, still further, the paste can be additional to plated metal on the opening sidewalls. These openings in the substrate are formed typically using mechanical drilling or laser ablation, following which the plating and/or conductive paste are be added.

In FIG. 1, a quantity of capacitor material 21 is positioned onto a first conductor member (hereinafter also referred to simply as conductor) 23, to an initial thickness of from about 0.2 mils to about five mils. A preferred method of applying material 21 is in liquid form, using, for example, a curtain, roller or draw-down coating process. Such application is also preferably accomplished in a roll-to-roll format. Alternatively, it is also possible to deposit material 21 in paste form using a screen printing operation or in ink form using a ink-jet printing operation. Material 21 is comprised of a thermosetting resin, a high molecular mass flexibilizer, and a quantity of nano-particles of a ferroelectric ceramic material. Significantly, the material forming the layer as shown is not applied onto a supporting web or the like material such as fiberglass mesh, and thus does not include continuous or semi-continuous fibers as part thereof. Equally significant, the coated material 21 may have a thickness of from about two to three microns, an extremely valuable characteristic when considering the microminiaturization demanded in many of today's electrical products such as substrates of the type defined herein. In one example, material 21 was coated to a thickness of only 2.5 microns.

A preferred thermosetting resin used for material 21 is an epoxy resin, and more preferably an epoxy novalac resin such as one sold under product designation “LZ 8213”, by Huntsman, Salt Lake City, Utah. Other acceptable thermosetting resins usable herein include high temperature diglycidyl ether, polyimide, cyanate ester (triazines), bismaleimide, bismaleimide and epoxy modified blend, benzoxazine, epoxy modified benzoxazine, halogen free benzoxazine, fluoropolymer, benzocyclobutene, perfluorobutane, polyphenylenesulfide, polysulfone, polyetherimide, polyetherketone, polyphenylquinoxaline, polybenzoxazole, polyphenyl benzobisthiazole and combinations thereof. In general the epoxy resin may be selected from the group including the diglycidyl ethers of resorcinol, catechol, hydroquinone, biphenol, bisphenol A, tetrabromobisphenol A, phenolaldehyde novolac resins, alkyl substituted phenolaldehyde resins, bisphenol F, tetramethylbiphenol, tetramethyltetrabromophenol, tetrachlorobisphenol A, and combination thereof. The cyanate esters, if used, may be selected from the group consisting of cyanatobenzene, dicyanatobenzene, 1,3,5-tricyanatobenzene, 1,3-, 1,4-, 1,6-, 1,8-, 2,6- or 2,7-dicyanatonaphthalene, 1,3,6-tricyanatonaphthalene, 4,4′-dicyanatobiphenyl, bis(4-cyanatophenyl)methane, 2,2-bis(4-cyanatophenyl)propane, 2,2-bis(3,5-dichloro 4-cyanatophenyl)propane, 2,2-bis(3,5-diblomo 4-dicyanatophenyl)propane, bis(4-cyanatophenyl)ether, bis(4-cyanatophenyl)thioether, bis(4-cyanatophenyl)sulfone, tris(4-cyanatophenyl)-phosphite, tris(4-cyanatophenyl)phosphate, bis(3-chloro-4-cyanatophenyl)methane, cyanated novolak derived from novolak cyanated disphenol type polycarbonate oligomer derived from bisphenol type polycarbonate oligomers, and combinations thereof.

A preferred high molecular mass flexibilizer used in this composition is phenoxy resin, and, in particular, one sold under the product name “PKHS-40” by the Inchem Corporation, having a business location at Rock Hill, S.C. Other high molecular mass flexibilizers include oligomeric resin and polymeric resin. When used, the phenoxy resin comprises from about five to twenty percent by weight of the capacitor material 21.

A preferred ferroelectric ceramic material used herein is barium titanate (BaTiO₃) powder available from Cabot Corporation under the product designation “BT-8”, Cabot Corporation having a business location in Boyertown, Pa. An alternative BaTiO₃ powder is also available from the Nippon Chemical Industrial Co., Ltd., of Tokyo, Japan. Other such ceramics include substituted barium titanate, strontium titanate, lead titanate, lead zirconate titanate, substituted lead zirconate titanate, lead magnesium niobate, lead zinc niobate, lead iron niobate, solid solutions of lead magnesium niobate and lead titanate, solid solutions of lead zinc niobate and lead titanate, lead iron tantalite, other ferroelectric tantalates, and combinations or mixtures thereof. Of importance, it has been determined that material 21 should include less than about eighty percent (by weight) of barium titanate in the material's final form (following heating), with more detailed examples below. Such a percentage is deemed important to assure non-flaking of the material following heating to remove the solvent carrier and partially advance the thermosetting resin thereof as defined below. The particles of the ferroelectric ceramic are nano-particles, having the dimensions cited above.

A preferred first conductor member 23 is a copper or copper alloy foil, having a thickness of from about 0.1 mils to about four mils, and, in the example above where material 21 is of a 2.5 micron thickness, is preferably one mil thick.

Following deposition, the capacitor material 21 (and conductor 15) is(are) heated to a temperature within the range of from about 120 degrees C. to about 140 degrees C. for a time period of from about two minutes to about four minutes. In one example, with a 2.5 micron material 21 thickness, the material (and conductor) was heated to 130 degrees C for approximately three minutes. This is preferably accomplished by placing the FIG. 1 structure within a suitable convection oven. Such heating, in addition to driving off residual organic solvents from the composition, also serves to at least partly cure the capacitor material. Most significantly, heating this size structure as defined has proven to substantially eliminate the possibility of the capacitor material from flaking, the deleterious results of such flaking being cited above.

Once the structure of FIG. 1 has cooled from the above heating, a second conductor member 25 is then applied atop the capacitor material 21. Member 25 is preferably of the same material and thickness as member 23. This layered member, also a solid sheet of copper or copper alloy, is preferably bonded to the formed layer of capacitor material 21 using conventional PCB lamination processing. Alternatively, layered member 25 may be formed atop material 21 using conventional sputtering processing. During such sputtering, a thin layer of the copper metal is vacuum deposited onto material 21. Such sputtering may also include depositing a barrier metal layer prior to the copper layer, such a barrier layer typically comprised of chrome or titanium with a thickness of 50 Angstroms to about 500 Angstroms. The sputtered copper layer may then be used as a seed layer for a subsequent electroplating of a copper layer, if desired. Other methods may be used for depositing the copper or copper alloy layer 25, and the invention is not limited to those described above. The lamination procedure, if used and at a sufficiently high temperature (and pressure), will serve to further cure the capacitor material from the partly cured state existing following the oven heating described above.

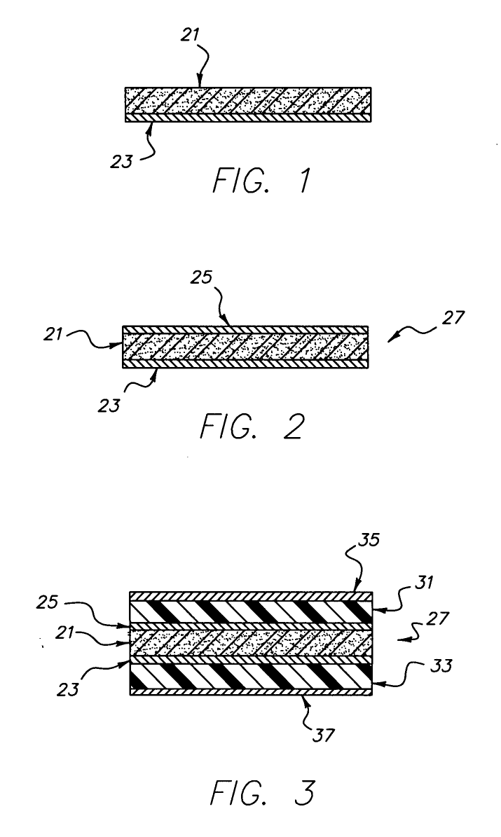

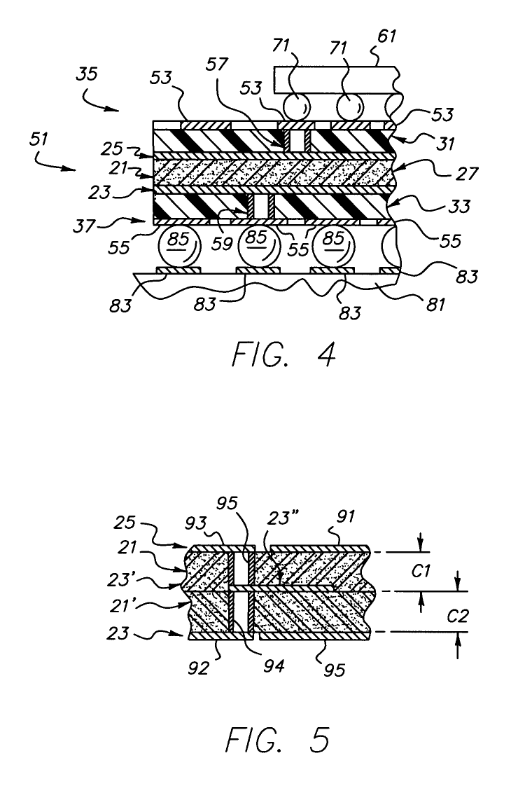

The three-layered structure of FIG. 2, in its simplest form as shown, is now capable of serving as a capacitor 27 within a capacitive substrate (below). The invention is not limited to said form, however, as it is often desirable to further process the FIG. 2 structure, including for example, to “personalize” each of the conductor layers 23 and 25. Such “personalizing” is known in the PCB art and typically includes use of photolithographic processing in which a photo-resist is applied to the metal conductors, exposed and developed, following which etching of selected (unprotected) portions of the conductor layers occurs. The result is a pattern of individual conductors, including possibly lines and/or pads. Selected ones of said lines and/or pads may then serve as the electrodes for the internal capacitor. Thus it is possible for each of the conductor layers 23 and 25 in FIG. 2 to include several individual pads or lines which will each serve as a capacitor electrode for a corresponding electrode on the opposite conductor. The conductors as shown in FIG. 2 (and FIG. 4) are thus shown in singular form for ease of explanation, it being understood that additional possible combinations are readily possible.

FIG. 3 represents some of the initial steps in forming a capacitive substrate according to one embodiment of the invention. In the FIG. 3 structure, layers 31 and 33 of dielectric material are added to the opposite sides (top and bottom) of the structure, following which conductor layers 35 and 37 are added. Layers 31 and 33 are preferably applied using conventional PCB lamination processing and equipment. Layers 35 and 37 are preferably also applied using such conventional lamination processing. Further description is not deemed necessary. Unlike the capacitor material 21, the dielectric materials usable for layers 31 and 33 include the aforementioned fiberglass-reinforced epoxy resin (some referred to as “FR-4” dielectric materials in the art), polytetrafluoroethylene (Teflon), polyimide, polyamide, cyanate resin and photo-imageable material. Other dielectric materials usable for layers 31 and 33 include bismaleimide, benzoxazine and halogen-free resin. Such material may be additionally reinforced with discrete ceramic particles added thereto. The conductor layers 35 and 37 are of similar material as layers 23 and 25, this being copper or copper alloy, and are formed from foil sheets of said material. In one embodiment, each dielectric layer may have a thickness of only about two mils, while the corresponding thickness of the outer conductor layer atop same may have a thickness of only about one mil. These are only meant as examples, however, and not intended to limit the invention. Significantly, capacitor 27 is now internally located within the multilayered structure of FIG. 3.

As with the structure of FIG. 2, the seven-layered structure of FIG. 3 may now be subjected to further processing, including the “personalizing” of each of the outer conductor layers 35 and 37. Such “personalizing” may be accomplished using the above described photolithographic processing as usable for previous outer conductor layers 23 and 25. Additionally, it may also be desirable to form thru-holes within selected portions of the structure prior to its final assembling to other electrical elements. The embodiment of FIG. 4 represents but one example of such further processing of the FIG. 3 structure, the result being a capacitive substrate 51 including internal capacitor 27 therein, and the shown additional dielectric and conductor layers. It should be added that the FIG. 3 structure is capable of further modification than as shown in FIG. 4. Specifically, it may be possible to add even more dielectric and conductor layers onto the formed capacitor member 27.

In FIG. 4, the outer conductor layers 35 and 37 have been “personalized” to now include a plurality of individual lines/pads 53 and 55, respectively. Additionally, thru-holes 57 and 59 are formed within layers 31 and 33, respectively. Each hole 57 and 59 is preferably formed by drilling, e.g., using a conventional mechanical drill or laser, and, following such drilling, each is plated initially with a first thin layer of palladium (as a “seed”), followed by a thin layer of electro-less copper and finally a thicker layer of electrolytic copper. In one embodiment, the total thickness of both copper layers combined is 0.5 mils. As is understood, other metallurgies and thicknesses are possible. Significantly, thru-hole 57 serves to electrically couple one of the pads 53 on layer 35 to the interim conductor layer 25. This pad and the adjacent thru-hole 57 are thus part of a circuit connected to layer (and now electrode) 25. Similarly, a selected one of the “bottom” pads 55 of layer 37 is coupled to the opposite layer (electrode 23) of capacitor 27. This pad 55 and the thru-hole are also part of the circuitry including the invention's capacitor. In the FIG. 4 embodiment, it is thus understood that an electrical component 61 such as a semiconductor chip (or even a chip carrier), when positioned atop capacitive substrate 51 and coupled thereto as shown (i.e., using a plurality of solder balls 71 of conventional material), is capable of being both electrically connected to selected signal, power and/or ground layers which may form part of the capacitive substrate, but also coupled to the internal capacitor 27. Likewise, another electrical structure such as a multilayered PCB 81, may also have substrate 51 positioned thereon and electrically joined thereto. And, further likewise, one or more of the PCB's pads/lines 83 (only one shown in FIG. 4) may be connected to the opposite side of capacitor 27 (i.e., also using solder balls 85, of conventional solder material). A circuit path is thus formed including this one pad/line 83, the attached solder ball 85, the single pad/line 55, thru-hole 59, capacitor 27, thru-hole 57, single pad 53 and attached solder ball 71, such that component 61 is capacitively coupled to underlying circuit structure (PCB) 81.

Although showing only one path including internal capacitor 27, the invention is also capable of having more than one such path, e.g., providing conductor member 25 with two isolated pads/lines and a corresponding paid within member 23. In such an example, two of the pads/lines 53 may be coupled to the capacitor. Likewise, two of the pads/lines 55 might also be connected to the opposite conductor 23. Two thru-holes would also be used as past of such a dual circuit path. Other combinations are also possible using the teachings herein. The structure of FIG. 5 is adapted for use in many environments, including particularly as part of an information handling system, e.g., a personal computer, mainframe computer or a computer server. Such a final system may include more than one such PCB 81, substrates 51 and components 61.

FIG. 5 depicts the formation of at least two capacitors C1 and C2 within a single capacitive substrate structure. The structure in FIG. 5 may be similar to that in the above FIGS. 3 and 4, with the addition of a second layer 21′ of capacitor material, and the provision of an interim conductor layer 23′ (shown by way of example as a single conductor 23″). Layer 21′ may be formed onto layer 23′ similarly as was layer 21 onto layer 23 in FIG. 1. Formation of a single conductor 23″ may then be formed by conventional procedures, including the aforementioned photolithographic processing. These capacitors may have similar or different values, again illustrating the versatility of the invention. In one example, C1 may have a value of 1 nF/inch² (nano-Farads per square inch), while C2 may possess a larger value of 100 nF/inch². Capacitor C1 is shown to comprise common electrode 23″ and electrode 91 (conductor 23″ in turn a part of a circuit including opposing conductors 92 and 93 due to connections via thru-holes 94 and 95, respectively, it being understood that one of said conductors may be eliminated, as may be the associated thru-hole). Capacitor C2 in turn is comprised of common electrode 23″ and electrode 95. Each electrode 91 and 95 may in turn be coupled to external components such as component 61 and PCB 81. Understandable, many different combinations of electrodes may be utilized to form two capacitors and the invention is not limited to the specific example shown. It needs to be understood further that the invention is not limited to one or two internal capacitors for a capacitive substrate and it is within the scope of the invention to provide many more, if operational requirements dictate. As with the substrate of FIG. 4, several additional conductor and dielectric layers may also be added, and preferably are, to the FIG. 5 embodiment. The following Table 1 represents examples of possible additional values for the paired capacitor embodiment of FIG. 5.

According to the teachings of the instant invention, it is possible to vary the capacitance values of the capacitors formed by varying the thicknesses of the capacitance dielectric materials and/or the materials themselves. The Examples cited below represent various materials which can be used, and Table 2 represents the various capacitance values when using alternative thicknesses and materials. (The capacitor material thickness dimensions in FIG. 5 are for illustration purposes only and may be adjusted as needed). This represents a significant aspect of this invention because it enables the substrate manufacturer to meet the operational requirements of many circuit designs by simply providing different capacitance dielectric materials and/or modifying the thicknesses thereof. A further significant aspect of the invention is that the capacitors formed may be connected to each other with the plated thru holes and/or circuit features on the conductor layers. These connections can be either series or parallel connections. Thus, with the various electrode sizes, dielectric materials and thicknesses, an infinite number of capacitor values can be achieved in a single substrate.

Two capacitors connected as shown in FIG. 5.

TABLE 1

| | | | | Total capacitor | Total capacitor |
|---|---|---|---|---|---|
| | Capacitance | | (0.1″ × 0.1″) | through series | through parallel |
| | Density | | Capacitor | connection | connection |
| Capacitors | (nF/inch2) | | (pF) | (1/C = 1/C1 + 1/C2) | (C = C1 + C2) |
| C1 | 1 | nF/inch2 | 10 | 9.9 pF | 1010 pF |
| C2 | 100 | nF/inch2 | 1000 | | |

Materials with different composition, thickness and capacitance density and thickness

TABLE 2

| | | | Capacitance Density | |
|---|---|---|---|---|
| Materials/Particle size | Thickness (microns) | | (nF/inch2) | |
| BaTiO3 (mean particle size | 2.0 | microns | 80 | nF/inch2 |
| 0.12 micron), Epoxy Novolac | | | | |
| Resin and high molecular | | | | |
| weight Phenoxy Resin - the | | | | |
| BaTiO3 comprising about 77 | | | | |
| percent by weight. | | | | |
| BaTiO3 (mean particle size | 25 | microns | 3 | nF/inch2 |
| 0.12 micron), Epoxy Novolac | | | | |
| Resin and high molecular | | | | |
| weight Phenoxy Resin - the | | | | |
| BaTiO3 comprising about 73 | | | | |
| percent by weight. | | | | |

The following Examples represent various combinations of capacitor dielectric materials and processes used to form capacitors according to various aspects of the invention. These are understood to be examples only and not limiting of the scope of this invention.

### EXAMPLE ONE

38.5 grams (gm) of epoxy novolac resin (e.g., one sold under product designation “LZ 8213” by Huntsman, having a business location at 500 Huntsman Way, Salt Lake City, Utah) containing about 35 percent by weight methyl ethyl ketone, and catalyzed with about 0.015 parts per hundred (PPH) of 2-methyl-imidazole and 12.8 gm of a high molecular weight, reactive thermoplastic phenoxy resin (e.g., the aforementioned one sold under the product name “PKHS-40” by the Inchem Corporation) containing 60 percent by weight methyl ethyl ketone, were mixed together with 100 gm of barium titanate (BaTiO₃) powder (available from Cabot Corporation, having a business location in Boyertown, Pa.). The barium titanate powder included a mean particle size of 0.12 microns and a surface area of 8.2 m²/gm. Also mixed in with this composition was 20 gm of methyl ethyl ketone. The composition was ball milled for one day, after which a thin coating of this well dispersed composition was wire-rod coated on a copper substrate (a copper foil) and dried at about 130 degrees C. for three minutes in a standard convection oven. This heating for this time period served to substantially remove all residual organic solvents. Following removal and cooling to room temperature, the coating exhibited substantially no flaking. The resulting capacitance density of the formed capacitor measured about twenty nano-Farads(nF)/square inch, with a dielectric loss of only about 0.02 at 1 Mega-Hertz (MHz). The measured coating thickness was about eight microns. Significantly, the barium titanate in this example comprised less than eighty percent by weight of the final layer material.

### EXAMPLE TWO

50 gm of epoxy novolac resin (e.g., the “LZ 8213” above by Huntsman, containing about 35 percent by weight methyl ethyl ketone and catalyzed with about 0.015 PPH of 2-methyl-imidazole, and 19.2 gm of the high molecular weight, reactive thermoplastic phenoxy resin “PKHS-40” (containing 60 percent by weight methyl ethyl ketone), were mixed together with 111 gm of barium titanate (BaTiO₃) powder from Cabot Corporation having the same mean particle size and surface area as in Example One (0.12 microns and 8.2 m²/gm, respectively). Also mixed in with this composition was 20 gm of methyl ethyl ketone. As also in Example One, the composition was ball milled for one day, after which a thin coating of this mixed composition was deposited on a copper substrate (a copper foil) and dried at about 130 degrees C. for three minutes in a standard convection oven. This heating for this time period also served to substantially remove all residual organic solvents. Following removal and cooling to room temperature, the coating exhibited substantially no flaking. The resulting capacitance density of the formed capacitor measured about three nano-Farads(nF)/square inch, with a dielectric loss of only about 0.02 at 1 Mega-Hertz (MHz). The measured coating thickness was about twenty-five microns. As in Example One, the barium titanate in this example comprised less than eighty percent by weight of the final layer material.

Thus there has been shown and described a capacitive substrate formed by using a capacitor material which exhibits substantially no flaking prior to its incorporation as part of the substrate (e.g., lamination thereof with other elements of the structure). Two or more capacitors may be formed as part of the capacitive substrate, as explained and illustrated herein. Importantly, the substrate may be formed using many conventional PCB processes to thereby reduce costs associated with production thereof. This capacitive substrate may also be incorporated into a larger, multilayered structure if desired, including one with more capacitive substrates as part thereof. Such incorporation is possible also using conventional PCB processing, in this case simple lamination at established pressures and temperatures. There have also been defined examples of capacitor materials which may be used. The invention as defined herein, if desired, is capable of transmitting both regular and high speed (frequency) signals, the latter at a rate of from about one Gigabit/sec to about ten Gigabits/second and even higher, while substantially preventing impedance disruption. Of further significance, the invention is able to utilize thru-holes of very fine definition and is able to assure highly dense circuit patterns, all of which are deemed extremely important to many of today's products using such substrates.

While there have been shown and described what at present are considered the preferred embodiments of the invention, it will be obvious to those skilled in the art that various changes and modifications may be made therein without departing from the scope of the invention as defined by the appended claims.

What is claimed is:

1. A capacitor material comprising a thermosetting resin, a high molecular mass flexibilizer, and a quantity of nano-particles of a ferroelectric ceramic material, said capacitor material not including continuous or semi-continuous fibers as part thereof and being adapted for being positioned in layer form on a first conductor member and heated to a predetermined temperature whereupon said material will not possess any substantial flaking characteristics, and thereafter adapted for having a second conductor member positioned thereon to form a capacitor member.

2. The capacitor material of claim 1 wherein said thermosetting resin is selected from the group consisting of epoxy resin, high temperature diglycidyl ether, polyimide, cyanate ester (triazines), bismaleimide, bismaleimide and epoxy modified blend, benzoxazine, epoxy modified benzoxazine, halogen free benzoxazine, fluoropolymer, benzocyclobutene, perfluorobutane, polyphenylenesulfide, polysulfone, polyetherimide, polyetherketone, polyphenylquinoxaline, polybenzoxazole, polyphenyl benzobisthiazole and combinations thereof.

3. The capacitor material of claim 1 wherein said high molecular mass flexibilizer is selected from the group consisting of phenoxy resin, oligomeric resin and polymeric resin.

4. The capacitor material of claim 3 wherein said high molecular mass flexibilizer is phenoxy resin and comprises from about five to twenty percent by weight of said capacitor material.

5. The capacitor material of claim 1 wherein said ferroelectric ceramic material is selected from the group consisting of barium titanate, substituted barium titanate, strontium titanate, lead titanate, lead zirconate titanate, substituted lead zirconate titanate, lead magnesium niobate, lead zinc niobate, lead iron niobate, solid solutions of lead magnesium niobate and lead titanate, solid solutions of lead zinc niobate and lead titanate, lead iron tantalite, other ferroelectric tantalates, and combinations or mixtures thereof.

6. The capacitor material of claim 5 wherein said ferroelectric ceramic material is barium titanate and comprises less than about eighty percent by weight of said capacitor material.

7. The capacitor material of claim 1 wherein said first conductor member comprises a layer of copper or copper alloy material.

8. The capacitor material of claim 7 wherein said second conductor member comprises a layer of copper or copper alloy material.

9. A capacitive substrate comprising:
a plurality of dielectric layers and a plurality of conductor layers; and
an internal capacitor positioned within said capacitive substrate, said internal capacitor including a first conductor member, a capacitor material positioned on said first conductor member and including a thermosetting resin, a high molecular mass flexibilizer, and a quantity of nano-particles of a ferroelectric ceramic material, said capacitor material not including continuous or semi-continuous fibers as part thereof and being adapted for being positioned in layer form on a first conductor member and heated to a predetermined temperature whereupon said material will not possess any substantial flaking characteristics, and a second conductor member positioned on said capacitor material.

10. The capacitive substrate of claim 9 wherein the dielectric material of at least one of said dielectric layers is selected from the group consisting of fiberglass-reinforced epoxy resins, polytetrafluoroethylene, polyimide, polyamide, cyanate resin, photo-imageable material, bismaleimide, benzoxazine, halogen-free resin and combinations thereof.

11. The capacitive substrate of claim 9 wherein at least one of said conductor layers is comprised of copper or copper alloy material.

12. The capacitive substrate of claim 9 wherein said thermosetting resin of said internal capacitor is selected from the group consisting of epoxy resin, high temperature diglycidyl ether, polyimide, cyanate ester (triazines), bismaleimide, bismaleimide and epoxy modified blend, benzoxazine, epoxy modified benzoxazine, halogen free benzoxazine, fluoropolymer, benzocyclobutene, perfluorobutane, polyphenylenesulfide, polysulfone, polyetherimide, polyetherketone, polyphenylquinoxaline, polybenzoxazole, polyphenyl benzobisthiazole and combinations thereof.

13. The capacitive substrate of claim 9 wherein said high molecular mass flexibilizer of said internal capacitor is selected from the group consisting of phenoxy resin, oligomeric resin and polymeric resin.

14. The capacitive substrate of claim 13 wherein said high molecular mass flexibilizer of said internal capacitor is phenoxy resin and comprises from about five to twenty percent by weight of said capacitor material.

15. The capacitive substrate of claim 9 wherein said ferroelectric ceramic material of said internal capacitor is selected from the group consisting of barium titanate, substituted barium titanate, strontium titanate, lead titanate, lead zirconate titanate, substituted lead zirconate titanate, lead magnesium niobate, lead zinc niobate, lead iron niobate, solid solutions of lead magnesium niobate and lead titanate, solid solutions of lead zinc niobate and lead titanate, lead iron tantalite, other ferroelectric tantalates, and combinations or mixtures thereof.

16. The capacitive substrate of claim 5 wherein said ferroelectric ceramic material of said internal capacitor is barium titanate and comprises less than about eighty percent by weight of said capacitor material.

17. The capacitive substrate of claim 9 wherein said first conductor member of said internal capacitor comprises a layer of copper or copper alloy material.

18. The capacitive substrate of claim 17 wherein said second conductor member of said internal capacitor comprises a layer of copper or copper alloy material.

19. The capacitive substrate of claim 9 further including an electrical component positioned on said capacitive substrate and electrically coupled to said internal capacitor, said electrical component and said internal capacitor forming an electrical assembly.

20. A method of making a capacitor member for use within a capacitive substrate, said method comprising;
providing a first conductor member;
positioning a quantity of capacitor material on said first conductor member, said quantity of capacitor material including a thermosetting resin, a high molecular mass flexibilizer, and a quantity of nano-particles of a ferroelectric ceramic material but not including continuous or semi-continuous fibers as part thereof,
heating said quantity of capacitor material on said first conductor member to a predetermined temperature for a predetermined time period such that said capacitor material will not possess any substantial flaking characteristics; and
thereafter positioning a second conductor member on said quantity of capacitor material.

21. The method of making a capacitor member of claim 20 wherein said first conductor member is provided in the form of a copper or copper alloy layer.

22. The method of making a capacitor member of claim 20 wherein said second conductor member is provided in the form of a copper or copper alloy layer.

23. The method of making a capacitor member of claim 20 wherein said positioning of said quantity of capacitor material on said first conductor member is accomplished using a coating process.

24. The method of making a capacitor member of claim 23 wherein said positioning of said second conductor member on said quantity of capacitor material is accomplished using lamination.

25. The method of making a capacitor member of claim 20 wherein said heating of said quantity of capacitor material on said first conductor member to a predetermined temperature comprises heating said capacitor material to a temperature within the range of from about 120 degrees C. to about 140 degrees C.

26. The method of making a capacitor member of claim 25 wherein said heating of said quantity of capacitor material on said first conductor member for said predetermined time period comprises heating said capacitor material for a time period of from about two to about four minutes.
